(19) United States
(12) Patent Application Publication
(10) Pub. No.: US 2017/0014984 A1
(43) Pub. Date: Jan. 19, 2017

(54) HIGH-POWER LIGHTWEIGHT TOOL

(71) Applicant: APEX BRANDS, INC., Apex, NC (US)

(72) Inventors: Martin Douglas Rola, Lexington, SC (US); Dave Wise, Lexington, SC (US); Ken Goodin, Lapeer, MI (US)

(21) Appl. No.: 15/206,690

(22) Filed: Jul. 11, 2016

Related U.S. Application Data
(60) Provisional application No. 62/193,374, filed on Jul. 16, 2015.

(51) Int. Cl. B25F 5/00; B23Q 9/00; B23Q 17/00

(52) U.S. Cl. CPC B25F 5/00; B23Q 17/007; B23Q 9/00

(57) ABSTRACT

A power tool may include a control unit, a hand tool body and a cable. The control unit may include a controller and at least one power unit. The hand tool body may be separate from the control unit. The hand tool body may include an end effector of the power tool. The end effector may be powered via the at least one power unit. The cable may operably couple the control unit and the hand tool body. The controller may be configured to communicate with the end effector and at least one other device external to the control unit. The hand tool body does not include any internal power source.

### CROSS-REFERENCE TO RELATED APPLICATIONS

This application claims priority to U.S. application No. 62/193,374 filed Jul. 16, 2015, the entire contents of which are incorporated herein by reference.

### TECHNICAL FIELD

Example embodiments generally relate to power tools and, in particular, relate to systems and architectures for improving ergonomics and access capabilities of such tools.

### BACKGROUND

Power tools are commonly used across all aspects of industry and in the homes of consumers. Power tools are employed for multiple applications including, for example, drilling, tightening, sanding, and/or the like. Handheld power tools are often preferred, or even required, for jobs that require a high degree of freedom of movement or access to certain difficult to reach objects.

Handheld power tools may have a number of different power sources. In this regard, for example, compressed air, mains electric power or batteries form common power sources. The power sources enable robust tools with multiple corresponding different uses to be put into action by operators in a number of different contexts.

In some specific industries, such as, but not limited to the automotive and aerospace industries, the operation and use of power tools may be subject to particular constraints. The constraints may include constraints from an ergonomic perspective relative to size and weight. In some cases, constraints may be introduced from an access perspective relative to reaching a required area for operation. In some other cases, constraints may be introduced from a process control perspective to ensure that the correct tool is being used in the correct manner.

A typical handheld power tool is a fully self-contained unit with a motor and gearing to drive some sort of end effector for a specific application. As mentioned above, power for the tool may be provided via a power source such as batteries to enable the tool user to have full mobility. However, the motor, gearing and battery, when all combined in a single tool housing, can make that tool rather heavy and/or large. As such, these self-contained units can, at times, begin to grow in size and weight in ways that can begin to create access problems.

Accordingly, it may be desirable to continue to develop improved mechanisms by which to implement ergonomic hand tools that have good access and process control capabilities.

### BRIEF SUMMARY OF SOME EXAMPLES

Some example embodiments may enable the provision of a power tool that employs a different structure to enhance the power tools capabilities without compromising the power tool relative to the constraints described above. Some example embodiments may also provide a system in which such power tools may be employed in connection with process control equipment.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a functional block diagram of a system that may be useful in connection with providing a system and power tool according to an example embodiment;

FIG. 2 illustrates a functional block diagram of a power tool according to an example embodiment;

FIG. 3 illustrates the power tool in a particular context with a user having equipment in accordance with an example embodiment;

FIG. 4 illustrates a block diagram of the power tool in a particular context with a seat having equipment in accordance with an example embodiment; and

FIG. 5 illustrates a block diagram of the power tool in a particular context with an assembly line having equipment in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

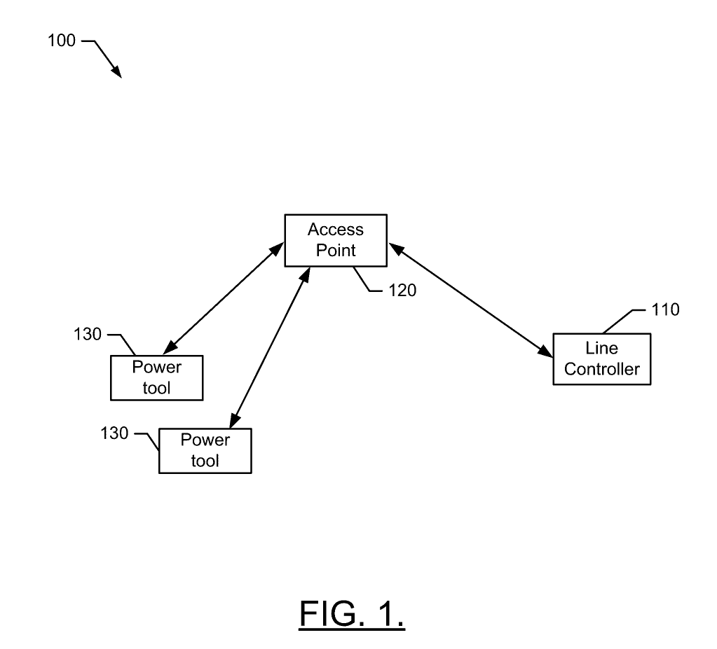

As indicated above, some example embodiments may relate to the provision of highly capable power tools that also have superior characteristics relative to granting access to certain areas. Such power tools may also have superior ergonomic properties and allow for process controls to be effectively implemented. FIG. 1 illustrates a functional block diagram of a system that may be useful in connection with providing a system and power tool according to an example embodiment.

As shown in FIG. 1, a system 100 of an example embodiment may include a line controller 110, an access point 120 and one or more power tools 130. The line controller 110 may be a computer, server, or other processing circuitry that is configurable to communicate with the power tools 130 via the access point 120 to provide process controls. The line controller 110 may therefore include one or more processors and memory that may be configurable based on stored instructions or applications to direct operation of the power tools 130. As such, the line controller 110 may provide guidelines, safety limits, specific operating instructions, and/or the like to various ones of the power tools.

The access point 120 may be configured to interface with the line controller 110 and the power tools 130 via wireless communication. As such, for example, the access point 120 may be a component of or forming a wireless local area network (WLAN) or LAN for communication with other components of the network. The communications may be accomplished using Bluetooth, WiFi, HIPERLAN or other wavebands. Each of the access point 120, the power tools 130 and the line controller 110 may include a communications module having an antenna and corresponding transmit/receive circuitry for facilitating communication over the network. In some cases, the communications over the network may be secured with encryption and/or authentication techniques being employed by the communications modules at the respective components of the network.

FIG. 1 illustrates two power tools 130, but it should be appreciated that the system 100 may operate with one power tool or may more than two power tools. Thus, two power tools are merely shown to exemplify the potential for multiplicity relative to the power tools 130 that could be employed with example embodiments. However, a single power tool 130 or additional power tools could be employed in alternative embodiments. The power tools 130 may be configured to employ wireless communication with the line controller 110 on a one-way (e.g., from the line controller 110 to the power tools 130 or vice versa) or two-way basis. As such, for example, in some cases, usage data for logging or activity tracking may be provided back to the line controller 110 from the power tools 130 responsive to operation of the power tools 130. Moreover, in some cases, the two-way communication may be employed for step-by-step or activity based interactive instruction provision that can be conducted on a real-time basis.

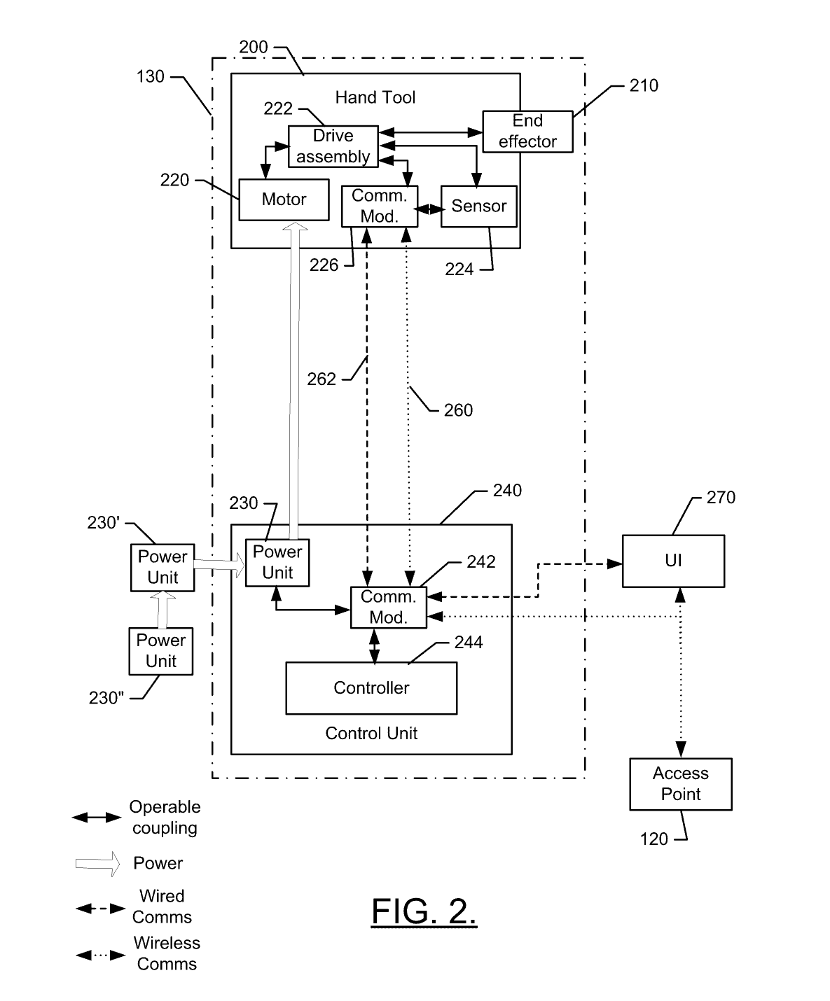

FIG. 2 illustrates a block diagram of components that may be employed in one of the power tools 130 in accordance with an example embodiment. As shown in FIG. 2, the power tool 130 may include a hand tool body 200 and an end effector 210. The hand tool body 200 may include a housing inside which a motor 220, a drive assembly 222, a sensor 224 and a communications module 226 may be provided. The end effector 210 may be the driven portion of the power tool 130, and may therefore be an attachment onto the hand tool body 200. However, in some cases, the end effector 210 and the hand tool body 200 may be incorporated as essentially the same device.

The end effector 210 may be a fastening tool, a material removal tool, an assembly tool, or the like. Thus, for example, the end effector 210 may be a nutrunner, torque wrench, socket driver, drill, grinder, and/or the like. The drive assembly 222 may include gearing and/or other drive components that convert the rotational forces transmitted by the motor 220 to perform the corresponding function of the end effector 210 for fastening, material removal and/or assembly. Thus, for example, the drive assembly 222 may include a gear set (e.g., a planetary or other suitable type of gear set) that converts rotational force provided by the motor 220 into a desirable form of force for operating the end effector 210. The motor 220 could be any type of motor. However, in an example embodiment, the motor 220 may be an AC or DC electric motor that is powered by an electric power source such as a battery or mains power. Thus, in an example embodiment, a power unit 230 from which the motor 220 is powered may be a removable and/or rechargeable battery pack. However, the power unit 230 could be a source of pressurized air or other power source in various other example embodiments. Moreover, in some cases, the motor 220 and power unit 230 could be a synchro/servo control system.

As shown in FIG. 2, the power unit 230 may be housed separately from the hand tool body 200 in a control unit 240. The control unit 240 could be an assembly that is commonly housed or supported separately from the hand tool body 200. In addition to housing (or supporting) the power unit 230, the control unit 240 may also house or support a communications module 242 and/or a controller 244. The control unit 240 may, in some cases, further house or support additional power units 230′ and 230″, which may be connected to the power unit 230 in series or parallel. As such, the additional power units 230′ and 230″ may be provided for redundancy or increased capacity, and they may be provided in the control unit 240 or may be otherwise operably coupled to and/or supported by the control unit 240.

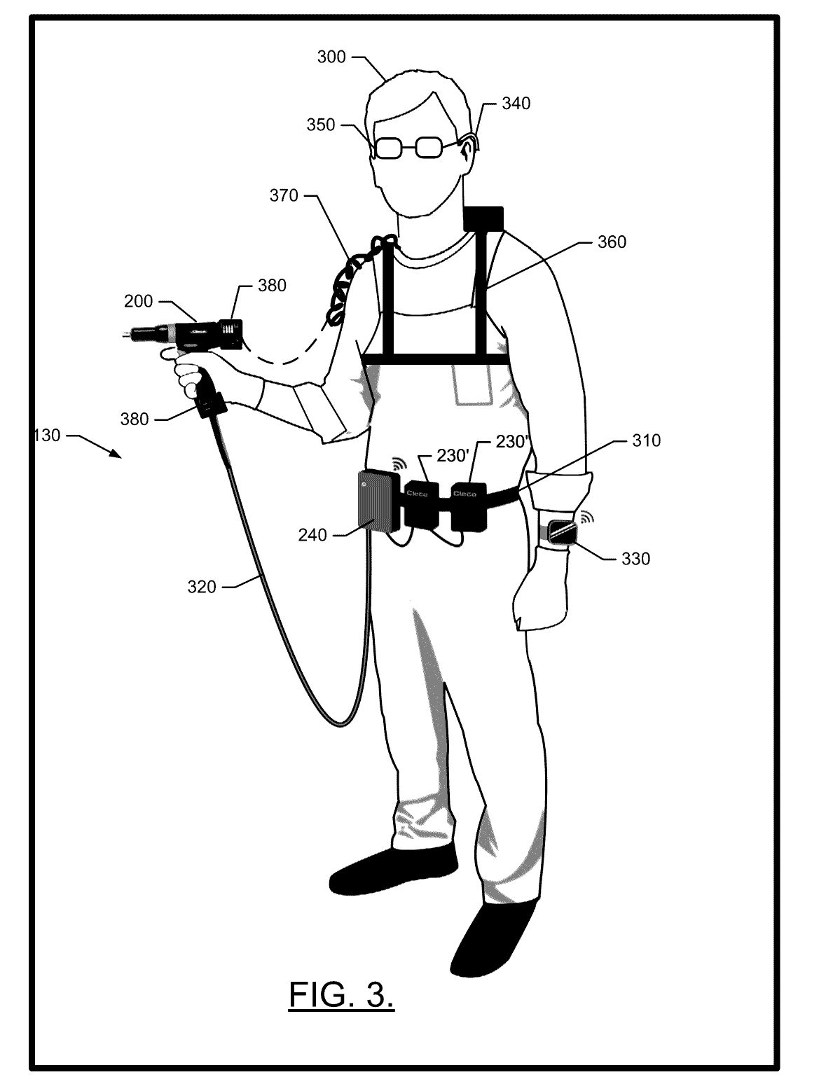

The communications modules 226 and 242 may include processing circuitry and corresponding communications equipment to enable the hand tool body 200 to communicate with the control unit 240 (and/or the access point 120) using wired or wireless communication techniques (as described above). Thus, in some cases, the communications modules 226 and 242 may support wireless communication via a wireless communication link 250. However, it is also possible for the communications modules 226 and 242 to communicate with each other via a wired communication link 252, which may pass through a cable that connects the hand tool body 200 to the control unit 240 (see cable 320 of FIG. 3). In such an example, the cable may also provide for power to be provided from the power unit 230 to the motor 220.

In some cases, the hand tool body 200 (and/or communication module 226) may also include processing circuitry and corresponding communications equipment to support communication with the end effector 210. The communications exchanged between the end effector 210 and the hand tool body 200 may include identification information that allows the end effector 210 to identify itself to the hand tool body 200 (e.g., by function, tool type, or specific tool identifier). The same type of identification capability may exist between the hand tool body 200 and the control unit 240. The controller 244 may access operating instructions correspondingly for the tool type or specific tool identifier of the end effector 210 and/or hand tool body 200 and provide control signals or other operating instructions to the end effector 210 and/or hand tool body 200 to control operation of the end effector 210 and/or hand tool body 200. As such, the communications may allow defined applications to be conducted and/or controlled at the end effector 210 and/or hand tool body 200. Such communications may also allow the hand tool body 200 to ensure that the correct end effector 210 is connected for the particular job to be accomplished or enable the controller 244 to ensure that the correct hand tool body 200 is connected. In some cases, each end effector 210 and/or hand tool body 200 may include an RFID tag or other identification component that can be read by a corresponding reader disposed at a portion of the hand tool body 200 or control unit 240, respectively, to communicate a tool identifier or other identification information back to the communication modules 226 and 242 and/or the controller 244. In some cases, the end effector 210 may further include a camera for socket identification and/or detection. The camera (if employed) may also provide an indicator for location detection.

In some cases, usage data, operational data and/or control data may also be communicated via the wireless communication link 250 and/or the wired communication link 252. As such, for example, the hand tool body 200 may communicate a start signal to the controller 244 and the controller 244 may provide instructions back to the hand tool body 200. Usage data may be recorded at the controller 244 based on the actions taken. In other examples, one or more transducers or other sensors (e.g., sensor 224) may be provided at the hand tool body 200 to sense operational data that can be communicated to the controller 244 for recording and/or for the controller 244 to use to make decisions regarding operation, or for notification of the user. The sensor 244 may detect reaction torque (e.g., on a ring gear or other component), current draw, or any other suitable information regarding operation of the motor 220, of the drive assembly 220, and/or of the end effector 210, which may be indicative of operational data that could facilitate operation of the hand tool body 200.

As shown in FIG. 2, the communication module 242 of the control unit 240 may enable communication with the access point 120. However, in some cases, the communication module 242 may further enable communication (e.g., wired or wireless) with a user interface (e.g., UI 270). The UI 270 may be a screen, display, lighting assembly or other such user interface that allows guidance, status or other information to be presented to the user before, during and/or after operation of the power tool 130. Thus, for example, the UI 270 may include an LCD display for process parameter display, or for the display of other information associated with usage of the power tool 130. In an example embodiment, the UI 270 may further include an illumination capability based on any lights that may be associated therewith. Thus, for example, the UI 270 may include one or more lights of various colors (e.g., white light or red/green LEDs) that can be used for illumination of the area around the hand tool body 200 or that may be used for OK/NOK signaling related to the end effector 210.

In an example embodiment, the power unit 230 (along with power units 230′ and 230″) may be embodied as a high capacity battery. As such, the power unit 230 may account for a substantial portion of the overall size and weight of the power tool 130. The controller 244 and any corresponding hardware associated therewith may also impose size restrictions on the power tool 130. By placing the power unit 230 and the controller 244 separate from the hand tool body 200, the weight and size of the hand tool body 200 may be reduced. The ability of the user to access small or restricted spaces with the end effector 210, and the ability of the user to operate effectively for longer periods of time without tiring, may therefore be enhanced.

FIG. 3 illustrates a power tool in a particular context with a user (e.g., operator 300) employing an example embodiment consistent with the descriptions herein. In this regard, as shown in FIG. 3, the operator 300 holds the hand tool body 200 in one hand and the control unit 240 is separately supported. Thus, for example, the control unit 240 may be provided on a utility belt 310 of the operator 300 so that the weight of the control unit 240 and any additional power units 230′ and 230″ can be more easily supported by the operator 300. The control unit 240 is operably coupled (e.g., for power and/or communications) to the hand tool body 200 via the cable 320. Although FIG. 3 shows the control unit 240 being supported by the utility belt 310, it should be appreciated that the control unit 240 could alternatively be provided on a backpack or harness 360, or may rest on the floor or another surface while the operator 300 employs the hand tool body 200. Of note, the utility belt 310 may also include one or more hooks, loops, holsters and/or the like to support other end effector options, such as angled heads and/or the like to swap out the end effector as needed. Sockets of different sizes could also be supported by the utility belt 310.

As shown in FIG. 3, a quick disconnect coupling 380 may connect the hand tool body 200 to the cable 320. The quick disconnect coupling 380 may permit the operator 300 to switch tools quickly and efficiently. Moreover, in some cases, different lengths or types of cable could be quickly changed out using the quick disconnect coupling 380. In some embodiments, the quick disconnect coupling 380 may connect the hand tool body 200 to a coiled cable 370 rather than the cable 320. In such embodiments, the coiled cable 370 may be used in order to prevent any cable from getting hung up on any machinery or other items and/or marring the vehicle (or other equipment) being worked on by the operator 300. Alternatively or in addition, the coiled cable 370 may be strapped to the arm of the operator 300 and/or routed through a shoulder or back harness 360 or a backpack to minimize dangling. Alternatively or in addition, the harness 360 or backpack may have a retraction mechanism to retract the coiled cable 370 or the cable 320 to prevent dangling. In some embodiments in which the control unit 240 and power units 230′ are enclosed in a housing, such housing, for example, may have a mar-resistant cover to avoid marring the vehicle (or other equipment). In addition, for example, if a backpack is employed, the backpack may include a cooling system (e.g., peltier chips and/or the like) to improve operator comfort and/or battery life.

In some cases any or all of the items supported by the utility belt 310 may be removed in a break-away fashion. Thus, for example, such components or items may be supported using Velcro or some other hook and loop type fastener. More rigid connections are also possible.

As shown in FIG. 3, the UI 270 of FIG. 2 may be embodied (at least partially) in the form of a wearable display 330 or head mounted wearable glasses 350. The wearable display 330 may be provided on a wrist, forearm or any other suitable part of the body of the operator 300, or may attach to the utility belt 310 and/or the hand tool body 200. The wearable display 330 could be worn on either hand. Moreover, when worn on the wrist or hand of the operator 300 at which the hand tool body 200 is being employed, specific instructions for control and/or positioning of the hand tool body 200 may be provided. Alternatively or in addition, the head mounted wearable glasses 350 may be worn on the face, and specific instructions for control and/or positioning of the hand tool body 200 may be provided on an optical display on a portion of the lens. For example, in conjunction with the camera (if employed), specific instructions for directional control of the hand tool body 200 may be provided (e.g., forward, back, right, left, etc.) to provide proper alignment and/or locating of the end effector 210. The control instructions may also indicate when to start or stop operation of the end effector 210, and/or how much torque has been applied. The wearable display 330 and/or glasses 350 may, of course, provide visual data, guidance, part pictures, operational instructions and/or the like. However, in other cases, feedback other than just visual feedback may be provided (e.g., haptic feedback such as vibrations). In some cases, the control unit 240, the glasses 350, and/or the wearable display 330 may further be in communication with an audio device 340 such as an earpiece or head set that the operator 300 may wear to receive audible feedback. The audio device 340 and the wearable display 330 may, for example, be operably coupled to the control unit 240 via Bluetooth or any other suitable short range communication link.

As shown in FIG. 3, the battery packs 230′ and 230″ may be daisy chained to increase speed, torque or duration of life for operation of the end effector 210. The battery packs 230′ and 230″ may be easily removable and/or replaceable to allow recharging of some battery packs to be accomplished while other battery packs are being used. As a result, the capacity for powering the end effector 210, both in terms of short term and long term operation, may be increased, while allowing the weight of the entire power tool 130 to be distributed. This architecture limits the size and weight of the hand tool body 200 portion of the power tool 130 to that which is easy and safe to handle in a person's hand without the addition of support arms/balancers that then limit the reach of the tools.

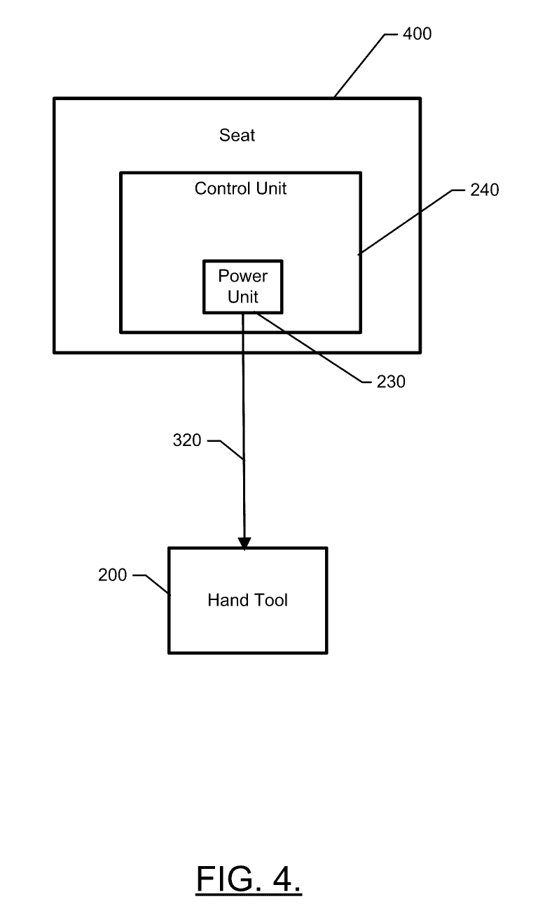

FIG. 4 illustrates a block diagram of a power tool in a particular context with a seat 400 having equipment in accordance with an example embodiment consistent with the descriptions herein. In this regard, as shown in FIG. 4, the seat 400 in which a person sits while working on a vehicle may include the control unit 240 and the power unit 230. The hand tool body 200 portion may be connected to the seat 400 (and, accordingly, the control unit 240 and power unit 230) via the cable 320. Accordingly, the transportation of the control unit 240 and the power unit 230 is facilitated by the movement of the seat 400.

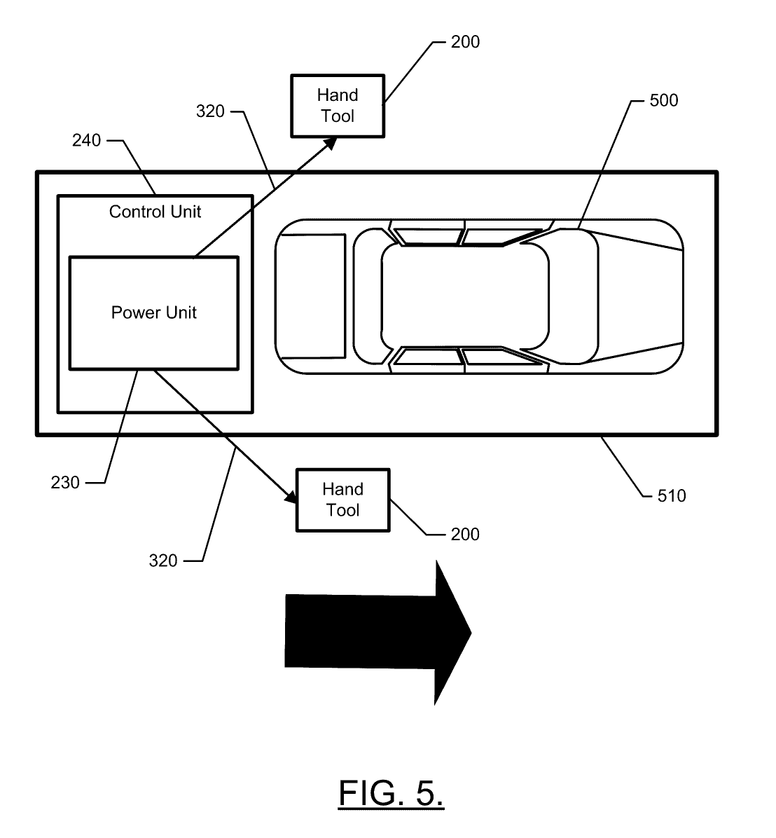

FIG. 5 illustrates a block diagram of a power tool in a particular context with an assembly line having equipment in accordance with an example embodiment consistent with the descriptions herein. In this regard, as shown in FIG. 5, the control unit 240 and power unit 230 are portable and may be carried along the assembly line 510 along with a vehicle 500 on which work is being performed. Furthermore, in an example embodiment, the control unit 240 and power unit 230 may actually be disposed within the vehicle (e.g., on or proximate to a seat also provided in the vehicle according to the example of FIG. 4). As such, different operators can plug into the control unit 240 and power unit 230 with different hand tools 200. The various hand tools 200 may be connected to the control unit 240 and the power unit 230 via multiple cables 320. As previously discussed, quick disconnect couplings 380 may facilitate the connection and disconnection of various hand tools 200 and types and/or lengths of cable 320. Operators may then climb into the vehicle (or chassis) and plug in a tool, use the tool and then exit the vehicle to allow the next operator to enter and plug in with similar convenience.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A power tool comprising:
a control unit including a controller and at least one power unit;
a hand tool body separate from the control unit, the hand tool body comprising an end effector of the power tool, the end effector being powered via the at least one power unit; and
a cable operably coupling the control unit and the hand tool body,
wherein the controller is configured to communicate with the end effector and at least one other device external to the control unit.

2. The power tool of claim 1, wherein the end effector is configured for execution of a material removal, assembly, or tightening function.

3. The power tool of claim 1, wherein communication between the controller and the end effector is accomplished via a wireless communication link.

4. The power tool of claim 1, wherein communication between the controller and the end effector is accomplished via a wired communication link provided in the cable.

5. The power tool of claim 1, wherein the control unit is supported on a utility belt.

6. The power tool of claim 5, wherein the control unit comprises at least one internal power unit and one or more external power units, the external power units being supported by the utility belt.

7. The power tool of claim 1, wherein the controller is operably coupled to a wearable display.

8. The power tool of claim 7, wherein device status, guidance or part images are displayed via the wearable display.

9. The power tool of claim 7, wherein haptic feedback is further provided via the wearable display.

10. The power tool of claim 7, wherein the wearable display is provided in glasses or on a wrist or hand of the operator.

11. The power tool of claim 1, wherein the controller is operably coupled to an audio device for providing audible feedback to an operator of the power tool.

12. The power tool of claim 1, wherein the controller is further configured to wirelessly communicate with a line controller via a wireless access point.

13. The power tool of claim 1, wherein the end effector is powered via a motor provided in the hand tool body, the motor being powered by the at least one power unit via the cable.

14. The power tool of claim 1, wherein the end effector is powered via a synchro/servo arrangement, and wherein a servo of the synchro/servo arrangement is provided at the control unit.

15. The power tool of claim 1, wherein at least one sensor is provided at the hand tool body to determine torque of the end effector.

16. The power tool of claim 1, wherein a camera is mountable at the hand tool body for component detection or guidance.

17. The power tool of claim 1, wherein the hand tool body does not include any internal power source.

18. The power tool of claim 1, wherein the cable comprises a quick disconnect coupling.

19. The power tool of claim 1, wherein the power tool may operably couple to a seat configured to house the control unit.

20. The power tool of claim 1, wherein the control unit is configured to move with an object on an assembly line to accommodate tools of different operators working the assembly line.
